(19) United States
(12) Patent Application Publication
(10) Pub. No.: US 2006/0068239 A1
(43) Pub. Date: Mar. 30, 2006

(54) Electric power source apparatus using fuel cell and method of controlling the same

(76) Inventors: Yasuaki Norimatsu, Hitachinaka (JP); Akihiko Kanouda, Hitachinaka (JP); Mutsumi Kikuchi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/211,635

(22) Filed: Aug. 26, 2005

(30) Foreign Application Priority Data
Sep. 30, 2004 (JP) 2004-287617

(51) Int. Cl. H01M 8/00

(52) U.S. Cl. 429/12

(57) ABSTRACT

A method of controlling an electric power source apparatus, which comprises supplying electric power to an electronic device on which a secondary battery is mounted from a power source apparatus having a fuel cell and an auxiliary power source. Electric power is supplied intermittently to a charging terminal of the electronic device by means of a switch for controlling conduction and interruption of an output terminal of the power source apparatus.

### CLAIM OF PRIORITY

This application claims priority from Japanese application Serial No. 2004-287617, filed on Sep. 30, 2004, the content of which is hereby incorporated by reference into this application.

### DESCRIPTION OF THE INVENTION

1. Field of the Invention

The present invention relates to an electric power source apparatus using a fuel cell and a method of controlling the apparatus.

2. Related Art

As a result of recent development in electronic technologies, rapid popularization of mobile phones, notebook personal computers (hereinafter referred to as notebook PC), audio-visual apparatuses or mobile terminal devices is going on. These portable devices are driven by secondary batteries. New type of secondary batteries appeared; they were downsized and made high-energy density. The batteries have changed from seal-lead batteries, Ni/Cd batteries, Ni hydrogen batteries to Li ion batteries. In any batteries, development of active materials and high capacity battery structures have been made so as to increase energy density and to realize electric power sources with a longer service time.

In the portable electronic devices, an attempt for low electric power consumption has been made enthusiastically. However, it is necessary to add new functions to meet increasing user's demands. Therefore, there is a tendency that the electric power consumption of the portable electronic devices will increase further. Accordingly, electric power sources with a high energy density and a longer continuous service time are needed.

In order to realize an electric power source with a long continuous service time by secondary batteries, the charging time is a critical issue. Thus, demands for small sized generators that do not need charging are increasing; as a solution of this object, fuel cells have been considered.

Fuel cells that use as fuel hydrogen produced by reforming are widely known. These fuel cells are operated at 80° C. or higher, but fuel cells that use liquid fuel are DMFC that directly oxidizes methanol at a fuel electrode. DMFC is safe with respect to temperatures; it is applied to mobile electronic devices as disclosed in patent document No. 1. Patent document No. 1: Japanese patent laid-open 2002-32154

Although fuel cells have volume energy density (WH/L) and weight energy density (Wh/kg) superior to conventional secondary batteries in high density, output density of the fuel cell is low. Accordingly, if fuel cells are mounted on electronic devices that need high outputs, an area for electric generation must be designed for generating the high output. Fuel cells with such a large generation area would have a size and weight approximately equal or more to those of the conventional secondary batteries.

As one application for high output mobile devices there are external charger types. The external battery charger for mobile devices needs a capability capable of outputting electric power equivalent to an AC adapter for the mobile devices; the charger should meet performance of the total output for driving electric power for the mobile device and a secondary battery mounted on the mobile device. However, because of low output density of the fuel cell it is very difficult to realize downsizing and lightweight of the electric power source apparatus when the fuel cell is mounted on the external battery charger for the mobile device. On the other hand, although the fuel cells can be made small-sized and lightweight but have a small generation area and a small output power, the fuel cells used as an exterior battery charger that requires a guaranteed power of the AC adapter for conventional devices are difficult to employ; the system can be applied to devices that are designed not to require an electric power larger than a certain value, which lacks reality.

### SUMMARY OF THE INVENTION

It is an object of the present invention to provide an electric power source apparatus, which can be used as an external battery charger without enlarging the size of a fuel cell and to a method of controlling the apparatus.

The present invention provides an electric power source apparatus with a high interchangeability, which can be used for the conventional devices as they are, wherein the apparatus is provided with, in addition to the electric power source, a high energy density power source such as a fuel cell, and as an auxiliary power source a high output density power source such as an electric double layer condenser, a Ni/hydrogen battery, a Li ion battery, which is used for HEVs or EVs.

The present invention relates to a method of controlling an electric power source apparatus having two kinds of electric power sources comprising a fuel cell and an auxiliary power source by which electric power is supplied to a charging terminal of an electronic device on which a secondary battery is mounted, wherein the electric power is intermittently supplied to the charging terminal of the electronic device by means of a switch capable of controlling conduction and interruption of the output terminal of the electric power source apparatus.

In the controlling method, the electric power is supplied to the charging terminal of the electronic device on which the secondary battery is mounted from the fuel cell and the auxiliary power source in parallel at the time of the conduction the output terminal of the electric power source apparatus.

Further, the present invention relates to an electric power source apparatus for supplying electric power to a charging terminal of an electronic device, which is provided with a fuel cell with an output smaller than the necessary maximum electric power of the electronic device and at least one kind of auxiliary electric power sources, the fuel cell and the auxiliary electric power source being disposed in parallel with each other.

### BRIEF DESCRIPTION OF THE DRAWINGS

FIG. 1 is a diagrammatic view of an electric power source apparatus of an embodiment according to the present invention.

FIG. 2 is a perspective view of an embodiment in which the preset invention is applied to a notebook personal computer.

FIG. 3 is a perspective view of a mobile phone to which the present invention is applied.

FIG. 4 is a perspective view of a mobile phone of another embodiment to which the present invention is applied.

FIG. 5 is a perspective view of a mobile device charger, which is able to exchange a cable that uses a USB terminal.

FIG. 6 is a diagrammatic view of an embodiment wherein the electric power source apparatus and an AC adapter cable are separable.

FIG. 7 is a flow chart for explaining the control of the electric power source apparatus of the present invention.

FIG. 8 is a chart showing electric power change of the fuel cell and EDLC of the electric power source apparatus of the present invention.

FIG. 9 is a chart showing a volume change in accordance with a design of electric power generation area of the fuel cell of the electric power source apparatus of the present invention.

FIG. 10 is a circuit diagram of another embodiment of an electric power source apparatus of the present invention.

FIG. 11 is a circuit diagram of further another embodiment of an electric power source apparatus of the present invention.

FIG. 12 is a circuit diagram of still another embodiment of an electric power source apparatus of the present invention.

FIG. 13 shows a comparison among voltage designs of the fuel cells in the embodiments 1 to 3.

FIG. 14 is a flow chart explaining the control of the electric power source according to embodiment 3.

FIG. 15 is a circuit diagram of an embodiment of an electric power source apparatus according to the present invention.

FIG. 16 is a flow chart for explaining the control of the electric power source apparatus of embodiment 4.

### EXPLANATION OF REFERENCE NUMERALS

Fuel cell; 1, electric double layer condenser; 2, judging-controlling means; 3, load breaking switch; 4, DC/DC converter; 5, EDLC charging switch; 6, fuel cell discharge switch; 7, Li ion battery; 8, electric power source apparatus; 10, AC adapter; 11, notebook PC; 12, mobile phone; 13, PDA; 14, emergency charging button; 20, constant voltage diode; 21

### DETAILED DESCRIPTION OF THE PREFERRED EMBODIMENTS

According to the embodiments of the present invention, downsizing, light-weight and cost-down of the electric power source apparatus can be realized and the apparatus can be applied to conventional electronic devices without changing specification.

In the following the electric power source apparatus and the method of controlling the apparatus will be explained. The present invention is not limited to the embodiments, and some of them can be combined.

### Embodiment 1

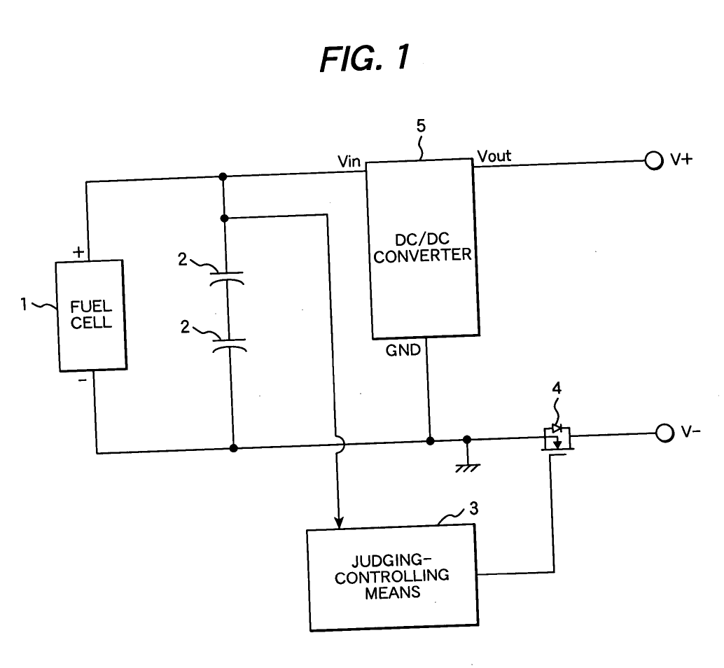

The embodiment 1 will be explained by reference to FIGS. 1 to 9. FIG. 1 is a block diagram showing a construction of the electric power source apparatus, and connections of power lines and signal lines. In this embodiment the number of fuel cells is set so that the maximum voltage of the fuel cell does not exceed the withstanding voltage of the electric double layer condenser.

In this embodiment the circuit has a fuel cell 1, which is used as a high energy density power source, and an electric double layer condenser (EDLC) 2, which is used as a high power density power source. The EDLC can be substituted by another secondary battery that generates a necessary power. In order to simplify the construction of the circuit, a direct methanol fuel cell (DMFC) is preferable for the fuel cell 1.

Although two EDLCs 2 are used in FIG. 1, the number of EDLC should be such that the maximum voltage calculated from the number of series fuel cells required for outputting electric power does not exceed the withstanding voltage of the EDLC. In considering that the maximum cell voltage of the unit cell is about 1.2 to 0.8 V, it is preferable to design the circuit in a manner that 2 to 4 cells of the fuel cells to one cell of EDLC 2 are disposed.

The circuit using the two kinds of the power sources comprises a DC/DC converter 5 for converting the output voltages of the power sources into a constant output voltage (a voltage between the Vout and GND), a load breaking switch 4 for controlling the supply to the load and interruption of the supply, and a judging-controlling means 3 for controlling ON and OFF of the load breaking switch 4.

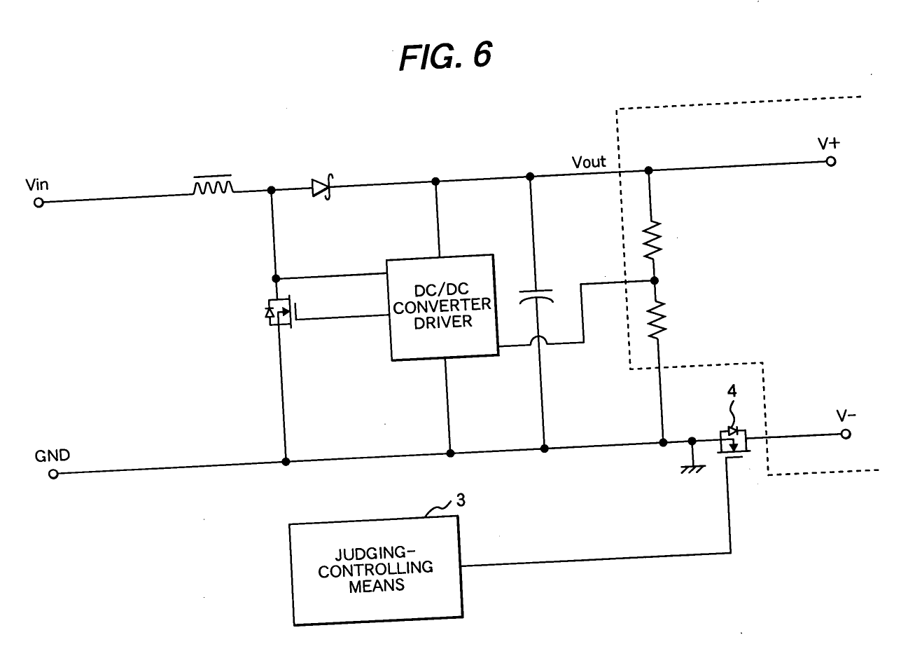

An example of the construction of the DC/DC converter 5 is shown in FIG. 6. The DC/DC converter 5 may be an insulated type (forward, fly-back, push-pull, etc) or a chopper type voltage booster converter, which is effective for lowering the number of the cells of the two kind power sources; depressive type converters or boosting type converters may be used according to load voltages.

In FIG. 6, a synchronous rectifier switch using a P channel power MOS FET may be used in place of a schottky diode. In FIG. 1, an N channel power MOS FET is used as the load breaking switch 4; the P channel power MOS FET can be used at the Vout side of the DC/DC converter 5, or other types of switches may be used.

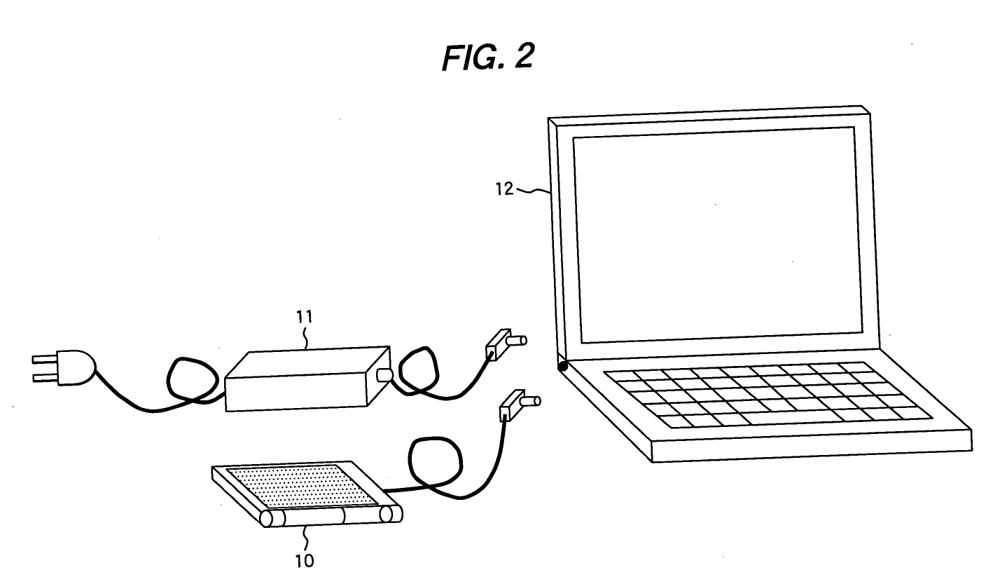

The electric power source apparatus of this embodiment will be explained by reference to FIGS. 2, 3, 4 and 5. FIG. 2 shows that the electronic device is a notebook PC 12. The electric power source apparatus 10 is interchangeable with an AC adapter 11 for the notebook PC. V+ and V−, which are connecting terminals for connecting the power source to the load in FIG. 1, are connectable with terminals of the AC adapter of the notebook PC; a voltage (16V, 19V, 20V, etc), which is interchangeable with the voltage of the AC adapter, is outputted from the DC/DC converter 5.

Terminal structures of AC adapters are poor in interchangeability because of difference in products of makers; output voltages differ from products to products such as 16 V, 19V, 20 V, etc. In order to solve the problem of non-interchangeability, the electric power source apparatus and the AC adapter cable are separated, which is shown in FIG. 6. As shown in FIG. 6, it is possible to alter an output voltage if the feed-back resistance portion of the DC/DC converter is built in the AC adapter cable side. Further, the interchangeability is increased by changing the shape of the AC adapter in accordance with the specification.

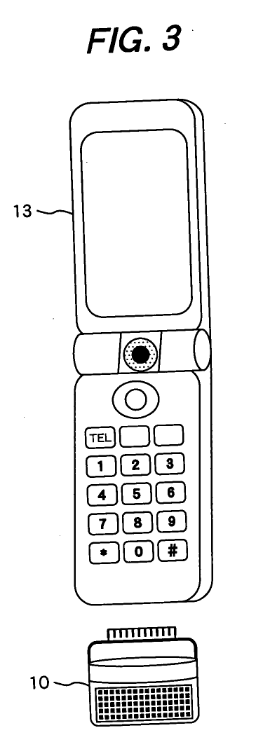

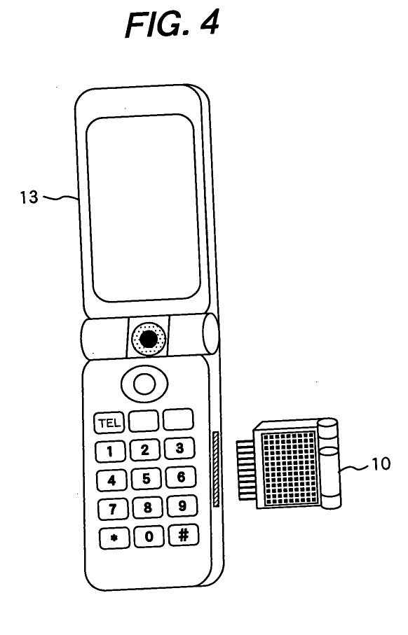

FIGS. 3 and 4 show examples of mobile phones 13. A voltage such as 5.5 V, which is interchangeable with the AC adapter of the mobile phone is outputted from the DC/DC converter between the V+ and V− in FIG. 1, which are connecting terminals to the load. Using the construction shown in FIG. 6 in this embodiment, it is possible to increase interchangeability by employing output voltages and adapter structures in accordance with specifications, becomes the section of the electric power source apparatus 10 and the section of the AC adapter cable are separated.

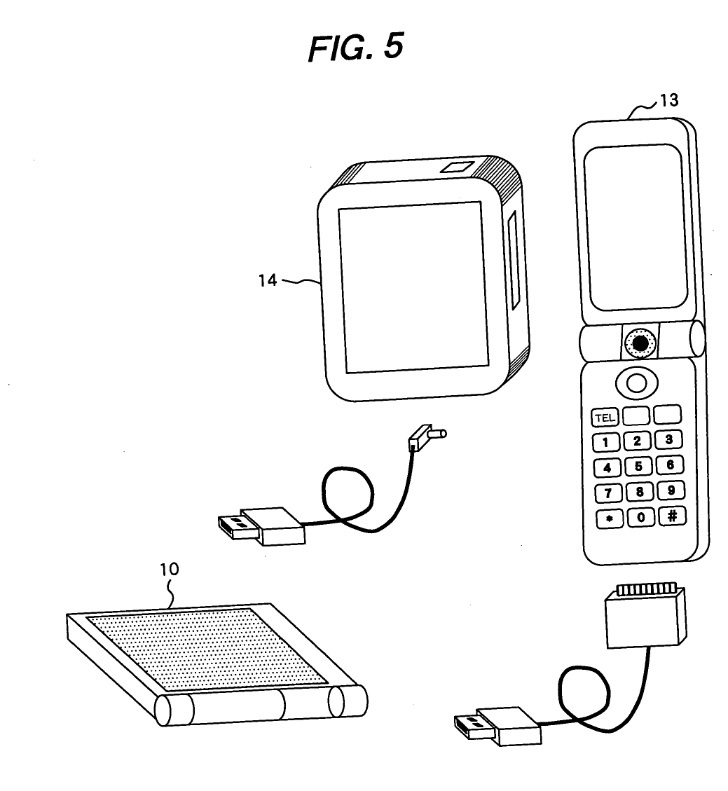

FIG. 5 shows a case where the electric power source apparatus is a Li ion battery, which is mounted on the electronic device. The Li battery has been used for mobile phones, MD3 player, portable media player, etc. As shown in FIG. 5, when a terminal at the electric power source side is a common terminal such as a USB terminal, the connection code is interchangeable. A voltage of 5 V, which is interchangeable with the USB terminal is outputted from the DC/DC converter 5 between the V+ and V− shown in FIG. 1. The USB terminal is used not only as a power source socket, but also as a means for transmitting information on various data such as a fuel residual amount, power source code to the portable devices.

Next, the controlling means and controlling method will be explained. As the judging-controlling means, a one-chip microcomputer, an exclusive IC or a comparator is used. The judging-controlling means 3 is provided with an A/D terminal and an input/output terminal. As an input signal, there are voltage-information of the EDLC 2 and various status judging signals, etc. As an output signal, there are an ON/OFF control signal to the load breaking switch 4 and ON/OFF control signal of the DC/DC converter.

In starting operation of the electric power source apparatus, a user controls the ON/OFF of the power source apparatus. The apparatus is provided with a main switch of which status is detected by the judging-controlling means 3. The supply of fuel or interchange of fuel cartridge is detected by the judging-controlling means 3. In case where fuel is directly supplied to fuel cell 1 by interchange of fuel by the user, the pressure rise in the fuel cell 1 is detected by the input terminal or A/D terminal of the judging-controlling means 3.

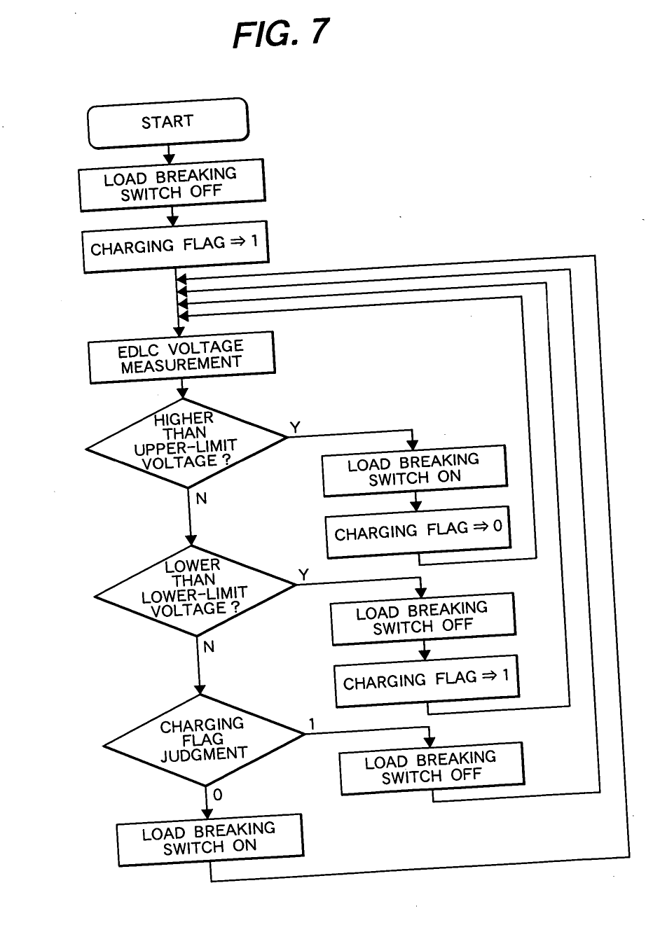

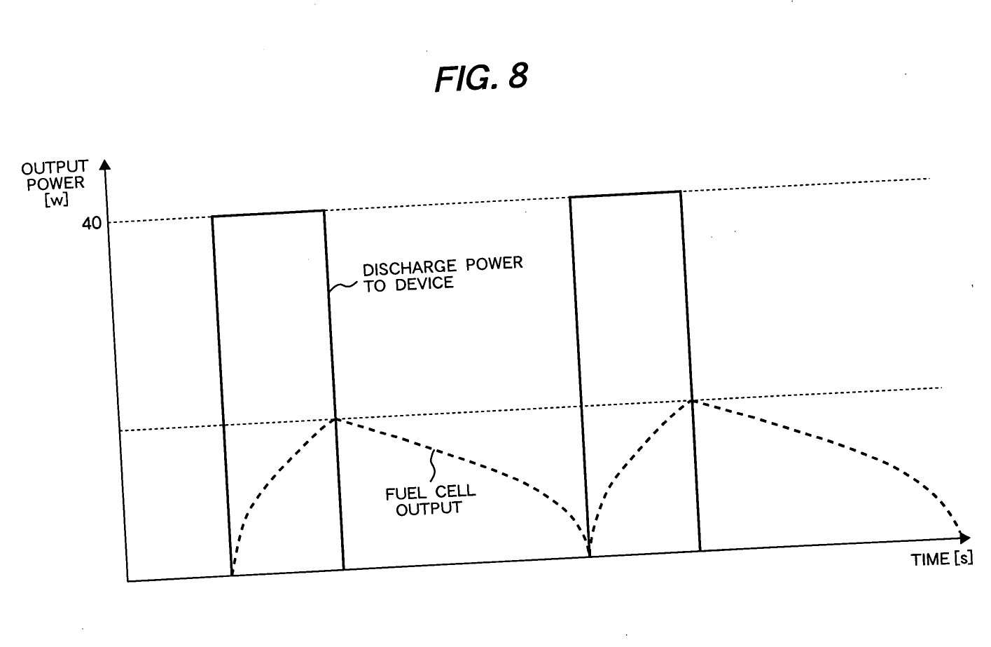

The normal operation will be explained by reference to FIGS. 7 and 8. When the voltage of EDLC 2 is detected by the A/D port of the judging-controlling means 3 to find that the voltage is above the preset upper limit voltage, operation is shifted to a discharge control. The judging-controlling means 3 makes the DC/DC converter 5 ON to start a pressure elevation operation. Thereafter, the means makes the load breaking switch 4 ON to start supply of electric power to the electronic device. In this state, the fuel cell 1 and EDLC 2 become almost the same voltage at the electric power source side, whereby the electric power can be supplied in parallel. If the required power of the electronic device is larger than the supply power of the fuel cell 1, the voltage of the fuel cell 1 and EDLC 2 becomes down as the discharge time elapses.

Then, the judging-controlling means 3 detects that the voltage of EDLC 2 is lower than the preset voltage by the A/D port, followed by charging operation. The judging-controlling means 3 makes the load breaking switch 4 OFF to cut supply of electric power to the electronic device, followed by making the DC/DC converter 5 OFF. At this state, the electric power source is the charging operation from fuel cell 1 to EDLC 2, resulting in a voltage rise of the EDLC 2 as the charging time elapses. Then, when the voltage of the EDLC 2 becomes a voltage higher than the preset voltage, the above routine is repeated.

As a result of repetition of the routine, the electronic device recognizes as if a user inserted or withdrawn the AC adapter, and the electronic device conducts switching operation accordingly. Thus, the electronic device selects a control program or a capacitance of the EDLC 2 so as to make the routine sufficiently long such as one second or longer or 5 second or longer, thereby to prevent abnormal action, which may be caused by inputting ON/OFF signals of the AC adapter into the electronic device at a high speed.

By employing the above mentioned construction and controlling method, the fuel cell 1 should not be designed to have such the power generation area that the fuel cell can output a large power (40 W, for example) necessary for the mobile notebook PC. Accordingly, about 15 W of the output of the fuel cell, which is an average power of the mobile notebook PC, is designed. That is, when a capacity of the AC adapter of the mobile notebook PC is 40 W, the EDLC 2 outputs about 25 W, which is equivalent to a difference between the fuel cell output and the AC adapter of the notebook PC, for several seconds to several ten seconds. The capacity of EDLC necessary for the above output several hundred F is several ten cc in volume. When the capacity of the AC adapter is about 3 W, EDLC 2 should have several cc in volume to output about 2 W for several seconds to about ten seconds, which corresponds to several F to about ten F.

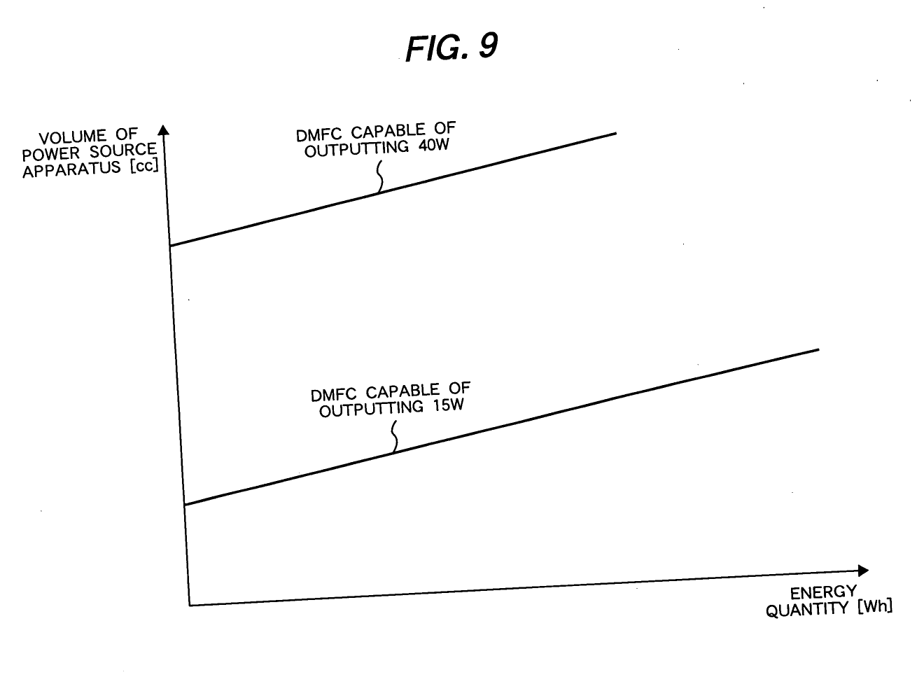

Comparison of volumes between electric power sources are shown in FIG. 9. The intersected portion on the volume axis at the energy quantity of zero represents the volume of the electric power source only. By adding a fuel tank or a fuel cartridge necessary for power generation, an energy quantity increases in proportion to the volume of the fuel. As shown in FIG. 9, it is apparent that the electric power source can be made smaller sized and light-weighted by above system than that of the fuel cell can supply 40 W of the AC adapter capacitor or almost all of the AC adapter capacitor. Although the power generation section of the fuel cell 1 uses a noble metal such as platinum, ruthenium, etc, which is expensive, an amount of the noble metal can be reduced to one severalfold (1/several) thereby to cost down because the power generation can be reduced to one severalfold.

### Embodiment 2

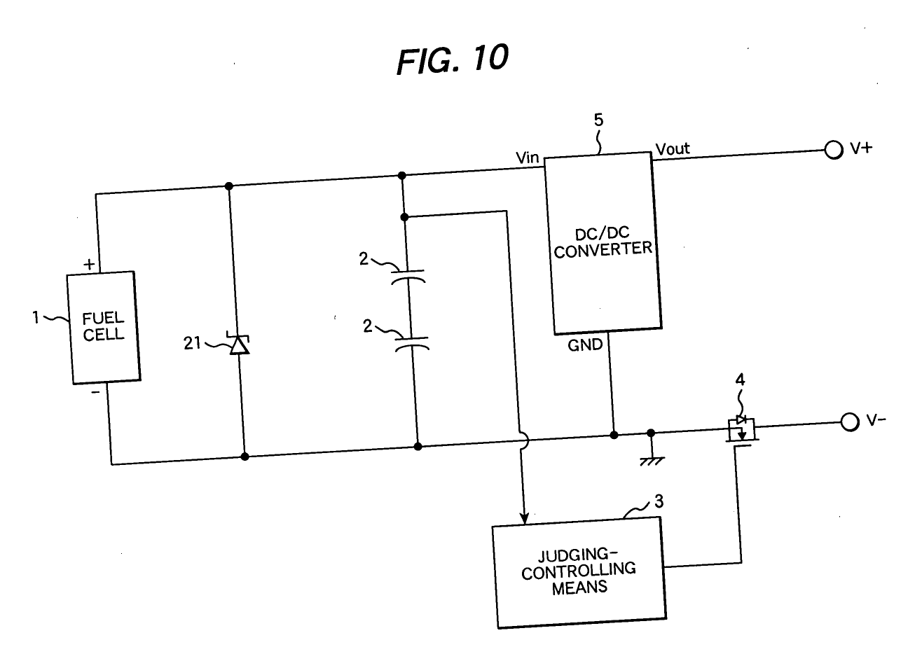

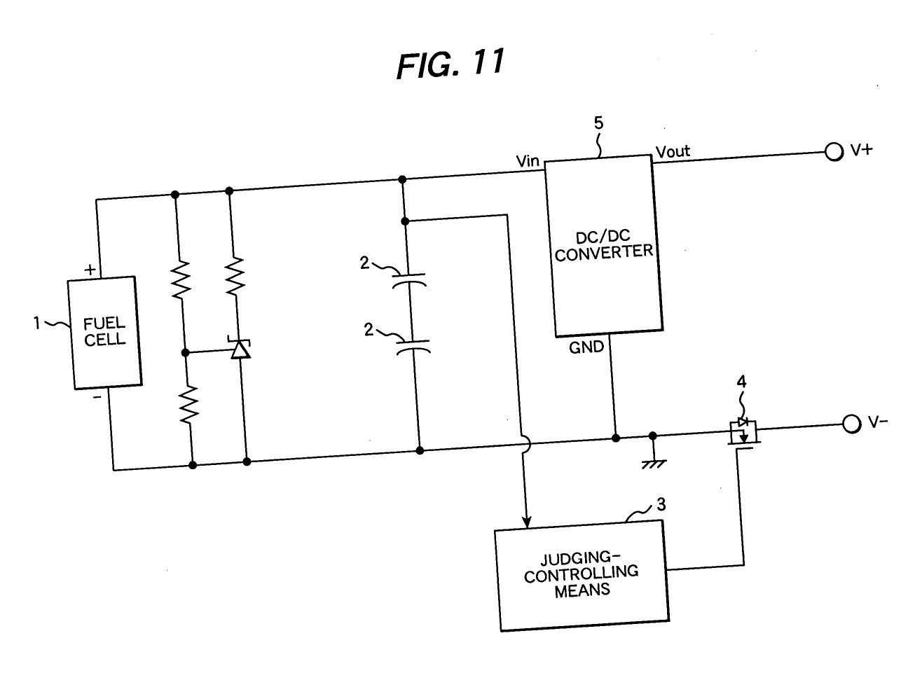

Embodiment 2 will be explained by reference to FIGS. 10 and 11. FIG. 10 is a block diagram of a circuit construction of the electric power source apparatus and connections of power lines and signal lines.

In case where a load on the fuel cell 1 is zero and the voltage becomes almost the natural potential, the voltage increases abruptly. In this embodiment, the system is provided with a function for cutting over-voltage to prevent damage of EDLC 2, which is caused by application of the over-voltage due to the increase of the voltage of the fuel cell 1 to the EDLC 2. As shown in FIG. 10, a constant voltage diode 21 is connected in parallel with the fuel cell thereby to cut a voltage applied to EDLC 2 to lower the voltage, which is lower than the withstanding voltage of EDLC 2. As shown in FIG. 11, the voltage higher than the preset voltage may be cut with a shunt regulator, or a resistor is connected in parallel with the fuel cell to realize the above mentioned function.

This embodiment greatly differs from embodiment 1 in a cell construction of the fuel cell 1 and EDLC 2. The maximum voltage per unit cell of the fuel cell 1 is 0.8 to 0.4 V by virtue of the voltage cutting function. It is preferable to design that the number of the fuel cells is 3 to 8 per one cell of EDLC 2 becomes larger. Accordingly, compared with embodiment 1, it is possible to design that the voltage difference between the upper limit and the lower limit of the charge-discharge of EDLC 2.

Although not shown in FIGS. 10 and 11, a thermistor or a temperature sensor for measuring a temperature of the fuel cell may be provided to the fuel cell thereby to input sensor signals. When a temperature of the fuel cell elevates, the judging-controlling means controls to increase the lower limit voltage. The temperature rise of the fuel cell is proportional to quantity of current output from the fuel cell; when the lower limit voltage is increased, quantity of current outputted from the fuel cell is restricted so that an excessive temperature rise of the fuel cell is prevented.

### Embodiment 3

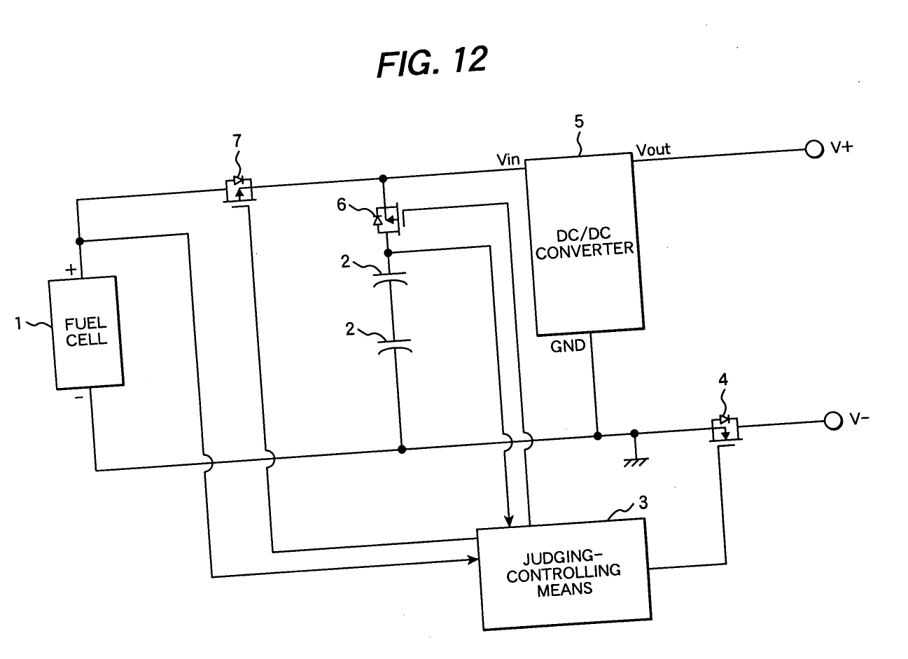

Embodiment 3 will be explained by reference to FIGS. 12 to 14. FIG. 12 is a block diagram showing a construction of the electric power source apparatus and connections of power lines and signal lines.

In this embodiment, in addition to the embodiments, a power region of the fuel cell where charge from the fuel cell to EDLC becomes faster. That is, compared to embodiment 2, the electric power source apparatus is so designed that a quantity of current that the fuel cell can output in the upper limit preset voltage of EDLC becomes larger.

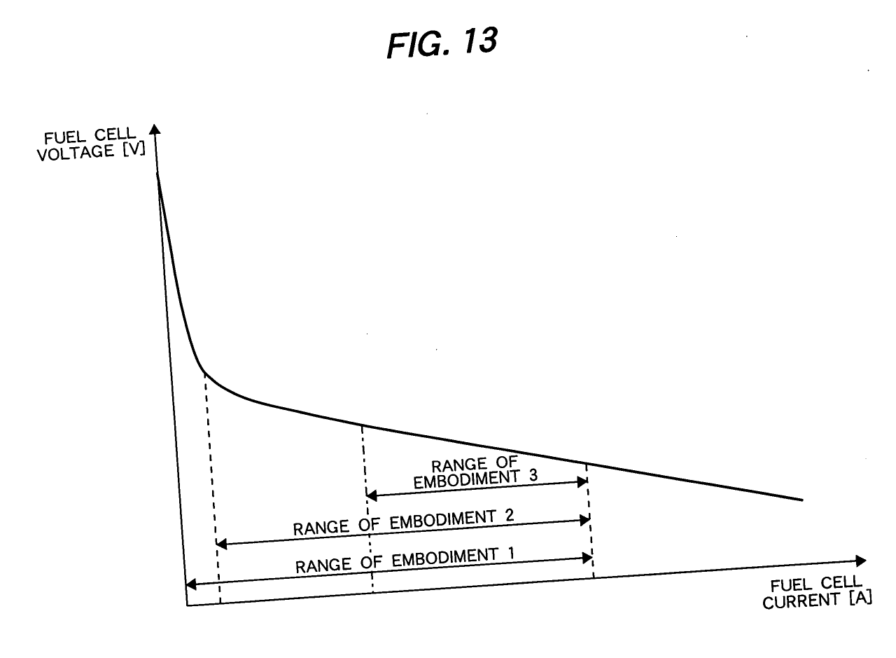

Comparisons of design ranges among embodiments 1 to 3 are shown in FIG. 13. The cell structure of the fuel cell and EDLC is changed in embodiment 3; the number of the fuel cells per one cell of EDLC is larger than that in embodiment 2. Accordingly, in the cell construction of this embodiment, there is an increased danger that voltage of the electric power source apparatus exceeds the withstanding voltage of the EDLC because the electric power source apparatus is not connected or the required electric power of the electronic device is very small. As a countermeasure to this ganger, the system is provided with an EDLC charging switch 6 that is capable of interrupting a charging path to the EDLC by using a P channel power MOS FET. Of course, it is possible to realize the function similar to one mentioned-above by employing a construction having two paths at the time of charging, which uses an N cannel power MOS FET at the GND side of the EDLC 2.

In this embodiment, there is provided a P channel power MOS FET as a fuel cell discharge switch 7 thereby to prevent backflow of current to lower a loss when the fuel in the fuel cell is zero, which may lead to backflow to the fuel cell or application of a reverse voltage to the fuel cell. In place of the above construction, a diode or a N channel power MOS FET at the GND side can be used. Further, the above elements may be omitted if there is no possibility of the backflow to the fuel cell because of a large self-discharge of EDLC.

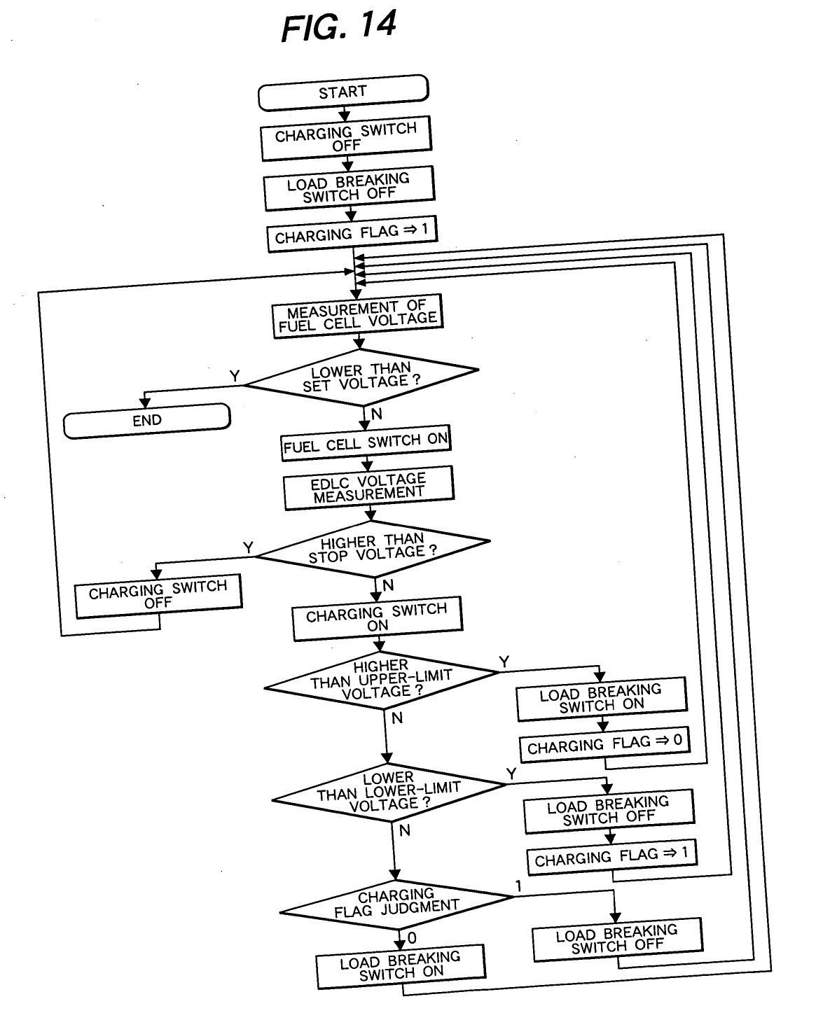

Next, a difference of this embodiment from embodiment 1 will be explained. In embodiment 1, an additional judgment for the normal operation is introduced to embodiment 1. The normal operation in embodiment 3 will be explained by reference to FIG. 14.

A charge stop voltage is newly set to switch off the charging switch thereby to stop charging of EDLC 2 at the voltage value higher than the upper limit voltage of EDLC 2. As a result, it is possible to prevent damage to EDLC due to the voltage that exceeds the withstanding voltage of EDLC.

### Embodiment 4

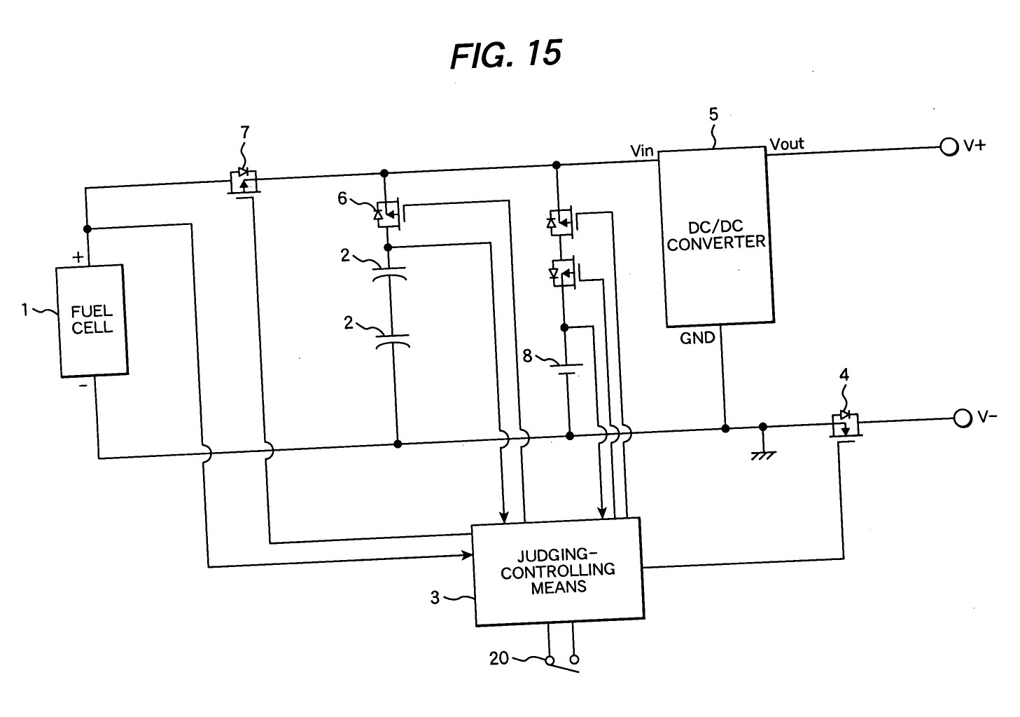

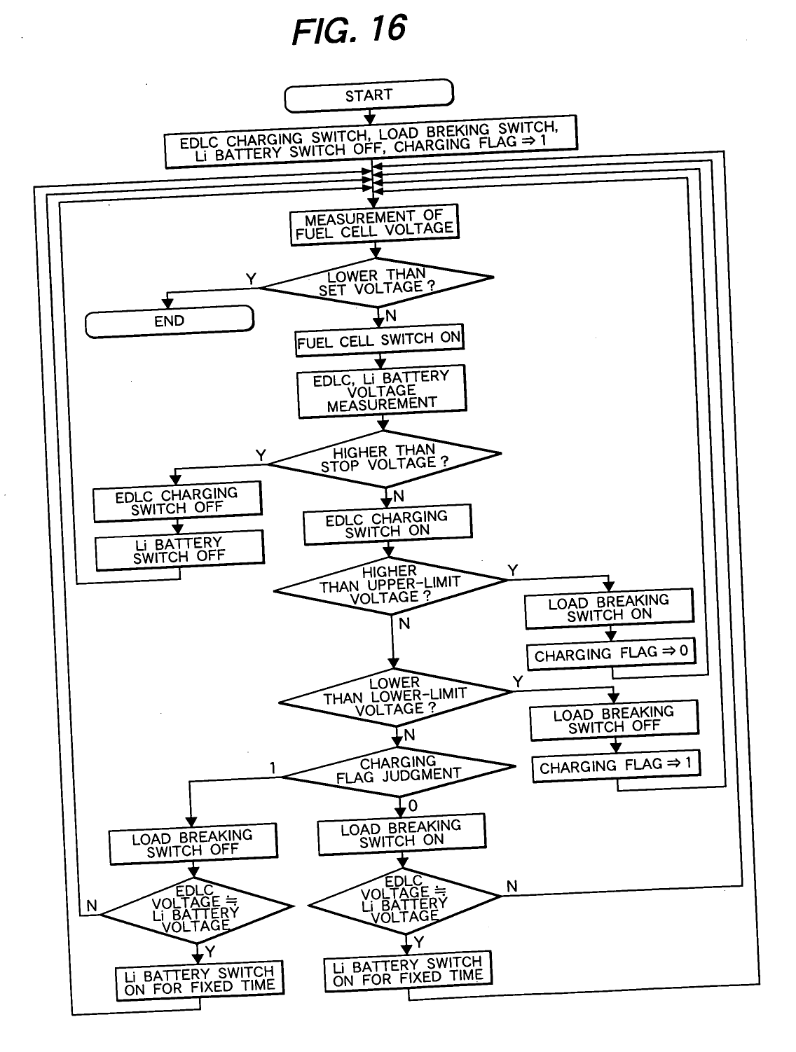

Embodiment 4 of the present invention will be explained by reference to FIGS. 15 and 16. FIG. 15 shows a construction of the electric power source apparatus and connections of power lines and signal lines.

In considering user's operation, there is an emergency case where a quick charging for preventing shutdown of the electronic device is needed when a residual energy amount of the battery mounted on the device is extremely small. The embodiment 4 has an additional secondary battery in addition to the construction of embodiment 2 so that the quick charging of the electronic device can be done. In this embodiment, the additional battery is a Li ion battery 8; a Ni hydrogen battery or other storage means may be employed, however.

The construction in this embodiment greatly differs from that of embodiment 2 in an emergency charging button 20 to be selected by the user, in addition to the additional battery. In this embodiment, a switch is employed; there is no limit as long as the judging-controlling means 3 can judge ON/OFF state. When the emergency charging button 20 is selected, discharging from the additional battery is carried out during the power supply to the electronic device thereby to make the power supply time longer. On the other hand, when the electric power supply from the additional battery to EDLC is done during the power supply to the electronic device is stopped, the power supply stop time is shortened. This means that the average supply power to the electronic device is increased.

Next, the operation in this embodiment will be explained by reference to FIG. 16. At first, operation of the power supply to the electronic device is explained. As shown in FIG. 16, the operation greatly depends on the state of the emergency charging button that is controlled by the user's operation. If there is no input of the emergency charging button, the operation is the same as in embodiment 1, the operation of which is switched by judgment of the preset lower limit voltage.

When there is an input of the emergency charging button, the operation is switched by comparing the voltages of EDLC and the additional secondary battery whose potentials are the same as that of the fuel cell because they output electric power in parallel. When the potential of the secondary battery is higher than that of EDLC, a discharge control of the secondary battery is not conducted. If the potential of EDLC is lower than that of the secondary battery, the secondary battery is conducted for a certain period of time. If the potential of the secondary battery is lower than the preset lower limit voltage, the operation becomes disable.

Next, the operation during the stop of power supply to the electronic device will be explained. As shown in FIG. 16, the operation is switched depending on whether the power supply time to the electronic device is within a certain period of time or not. If the power supply time is shorter than the certain time, the operation is the same as in embodiment 1; the operation is switched by the judgment of the preset upper limit voltage. If the power supply time is longer than the certain time, the operation is switched by comparing the voltages of EDLC charged with the fuel cell and the additional secondary battery. If the voltage of the secondary battery is higher than that of EDLC, charging control of the secondary battery is not conducted.

According to the present invention, it is possible to solve the problem that the fuel cell should have been a large sized when the exterior battery charger of the electronic device mounting the secondary battery is realized by the fuel cell.

What is claimed is:

1. A method of controlling an electric power source apparatus, which comprises: supplying electric power to an electronic device on which a secondary battery is mounted from the electric power source apparatus having a fuel cell and an auxiliary power source, wherein electric power is supplied intermittently to a charging terminal of the electronic device by means of a switch for controlling conduction and interruption of an output terminal of the electric power source apparatus.

2. The method of controlling the electric power source apparatus according to claim 1, wherein at the time of the conduction of the output terminal of the electric power source apparatus, electric power is supplied in parallel to the charging terminal of the electronic device from both the fuel cell and the auxiliary power source, and at the time of the interruption of the output terminal, the auxiliary power source is charged.

3. The method of controlling the electric power source apparatus according to claim 1, wherein the auxiliary power source is an electric double layer condenser.

4. The method of controlling the electric power source apparatus according to claim 1, wherein the auxiliary power source is a secondary battery.

5. The method of controlling the electric power source apparatus according to claim 3, wherein the capacity of the electric double layer condenser is so adjusted that the electric power supply time to the electronic apparatus is one second or longer.

6. The method of controlling the electric power source apparatus according to claim 2, wherein power supply to the charging terminal of the electronic device is started when the voltage of the auxiliary power source reaches an upper-limit threshold value and the interruption of the output terminal is conducted when the voltage of the auxiliary power source reaches a lower-limit threshold value.

7. The method of controlling the electric power source apparatus according to claim 6, wherein the lower-limit threshold value is increased in accordance with a temperature increase of the fuel cell.

8. An electric power source apparatus for supplying electric power to a charging terminal of an electronic device, which comprises a fuel cell with an output smaller than the minimum necessary electric power for the electronic device and at least one kind of an auxiliary power source, wherein the fuel cell and the auxiliary power source are constructed to supply electric power to the electronic device in parallel with each other.

9. The electric power source apparatus according to claim 8, wherein the electronic device has a secondary battery mounted thereon.

10. The electric power source apparatus according to claim 9, wherein the guaranteed power of the fuel cell is set to be close to the driving average power of the electronic device.

11. The electric power source apparatus according to claim 8, which further comprises a switch for controlling conduction and interruption of the output terminal to which electric power is supplied to the electronic device from the fuel cell and the auxiliary power source.

12. The electric power source apparatus according to claim 11, which further comprises a DC/DC converter for converting a voltage supplied from the fuel cell and the auxiliary power source to the electronic device into a constant output voltage.

13. The electric power source apparatus according to claim 2, which further comprises a judging-controlling means for controlling at least one of ON/OFF of the switch and ON/OFF of he DC/DC converter.

14. The electric power source apparatus according to claim 12, which is interchangeably provided with a power-transmission cable for supplying electric power to the electronic device and is provided with a feedback resistance in the power-transmission cable for deciding the output voltage of the DC/DC converter.

15. The electric power source apparatus according to claim 11, which is interchangeably provided with a power-transmission cable for supplying electric power to the electronic device, wherein the power-transmission cable is a USB terminal.

16. The electric power source apparatus according to claim 9, wherein the auxiliary power source is an electric double layer condenser.

17. The electric power source apparatus according to claim 9, wherein the auxiliary power source is an electric double layer condenser and a secondary battery.
